(19) United States
(12) Patent Application Publication
(10) Pub. No.: US 2015/0091894 A1
(43) Pub. Date: Apr. 2, 2015

(54) METHOD AND APPARATUS FOR TRACING RAY USING RESULT OF PREVIOUS RENDERING

(71) Applicant: Samsung Electronics Co., Ltd., Suwon-si (KR)

(72) Inventors: Young-sam SHIN, Hwaseong-si (KR); Won-jong LEE, Seoul (KR); Jae-don LEE, Yongin-si (KR)

(73) Assignee: SAMSUNG ELECTRONICS CO., LTD., Suwon-si (KR)

(21) Appl. No.: 14/260,374

(22) Filed: Apr. 24, 2014

(30) Foreign Application Priority Data
Oct. 2, 2013 (KR) 10-2013-0118132

(51) Int. Cl. G06T 15/06

(52) U.S. Cl. CPC G06T 15/06
USPC 345/419

(57) ABSTRACT

Provided is a ray tracing method including extracting, at a ray scanner, characteristics of a ray generated to render a current frame, determining a ray having characteristics similar to that of the generated ray based on comparing the characteristics of the generated ray with characteristics of rays used to render a previous frame, and performing ray tracing of the generated ray based on a result of ray tracing of the determined ray.

### RELATED APPLICATIONS

This application claims the benefit under 35 USC 119(a) of Korean Patent Application No. 10-2013-0118132, filed on Oct. 2, 2013, in the Korean Intellectual Property Office, the entire disclosure of which is incorporated herein by reference for all purposes.

### BACKGROUND

1. Field

The present disclosure relates to methods and apparatuses for rendering by ray tracing.

2. Description of Related Art

3D rendering refers to image processing whereby 3D object data is synthesized into an image viewed at a given viewpoint of a camera. Ray tracing refers to a process of tracing a point where scene objects and a ray intersect. Ray tracing includes traversal of an acceleration structure and an intersection test between a ray and a primitive. In the traversal and the intersection test, a large amount of computation and a broad memory bandwidth are needed. Thus, it is desirable to reduce the computation and the bandwidth.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to an aspect, a ray tracing method includes extracting, at a ray scanner, characteristics of a ray generated to render a current frame, determining a ray having characteristics similar to that of the generated ray based on comparing the characteristics of the generated ray with characteristics of rays used to render a previous frame, and performing ray tracing of the generated ray based on a result of ray tracing of the determined ray.

The performing of the ray tracing may comprise initially traversing a bounding box of an acceleration structure that is hit by the determined ray.

The performing of the ray tracing may comprise traversing a second bounding box of the acceleration structure, in response to the bounding box not being hit.

The bounding boxes farther from a viewpoint of the ray than the bounding box may not be traversed.

The performing of the ray tracing may comprise initially performing an intersection test on a primitive in the acceleration structure that is hit by the determined ray.

The determining of the ray may comprise determining the rays whose viewpoint and direction are within a predetermined range from a viewpoint and a direction of the generated ray as belonging to a group, and the performing of the ray tracing may comprise performing the ray tracing of the generated ray based on a result of ray tracing of rays of the group.

The extracting may comprise extracting a viewpoint and a direction of the generated ray in response to the generated ray being a primary ray, and extracting a starting point and a direction of the generated ray in response to the generated ray being a secondary ray.

The determining of the ray may comprise comparing a viewpoint and a direction of the generated ray and viewpoints and directions of the rays used to render the previous frame to determine the ray having a viewpoint and a direction similar to the viewpoint and the direction of the generated ray.

The method may include storing a result of ray tracing of the generated ray, wherein the result of the ray tracing comprises information indicating a bounding box or a primitive that is hit by the generated ray.

According to another aspect, a ray tracing apparatus including a ray scanner configured to extract characteristics of a ray generated for rendering a current frame, a data manager configured to determine a ray having characteristics similar to that of the generated ray based on comparing the characteristics of the generated ray with characteristics of rays used in rendering a previous frame, and a ray tracer configured to perform ray tracing of the generated ray based on a result of ray tracing of the determined ray.

The ray tracer may be further configured to initially traverse a bounding box of an acceleration structure that is hit by the determined ray.

The ray tracer may be further configured to exclude traversal of the bounding box that is farther from a viewpoint of the ray than the bounding box hit by the determined ray.

The ray tracer may be further configured to initially performs an intersection test on a primitive in an acceleration structure that is hit by the determined ray.

The data manager may be further configured to determine rays whose viewpoint and direction are within a predetermined range from a viewpoint and a direction of the generated ray as belonging to a group, and the ray tracer may be further configured to perform ray tracing of the generated ray based on a result of ray tracing of rays of the group.

The ray scanner may be further configured to extract a viewpoint and a direction of the generated ray in response to the generated ray being a primary ray, and to extract a starting point and a direction of the generated ray in response to the generated ray being a secondary ray.

The data manager may be further configured to compare viewpoints and directions of the generated ray and viewpoints and directions of the rays used to render the previous frame to determine the ray having a viewpoint and a direction similar to the viewpoint and the direction of the generated ray.

The data manager may be further configured to store a result of ray tracing comprising information indicating a bounding box or a primitive that is hit by the generated ray.

According to another aspect, a ray tracing apparatus including a ray scanner configured to extract characteristics of a ray generated for rendering a current frame, and a data manager configured to determine a ray having characteristics similar to that of the generated ray based on comparing the characteristics of the generated ray with characteristics of rays used in rendering a previous frame, wherein the data manager is further configured to control at least one of a TRV unit or a IST unit to perform ray tracing of the generated ray based on a result of ray tracing of the determined ray.

The TRV unit may be configured to initially traverse a bounding box of an acceleration structure that is hit by the determined ray.

The IST unit may be configured to initially performs an intersection test on a primitive in an acceleration structure that is hit by the determined ray.

Other features and aspects will be apparent from the following detailed description, the drawings, and the claims.

### BRIEF DESCRIPTION OF THE DRAWINGS

FIG. 1 is a diagram illustrating an example of a ray tracing method.

FIG. 2 is a diagram illustrating an example of a ray tracing core.

FIG. 3 is a diagram illustrating an example of ray tracing performed by a ray tracing core.

FIG. 4 is a diagram illustrating an example of a method of accelerating ray tracing.

FIG. 5 is a diagram illustrating an example of a method of accelerating ray tracing of FIG. 4.

FIG. 6 is a diagram illustrating an example of a ray tracing apparatus.

FIG. 7 is a diagram illustrating an example of a ray tracing method.

FIG. 8 is a diagram illustrating an example of a ray tracing apparatus.

FIG. 9 is a diagram illustrating an example of a ray tracing core.

FIG. 10 is a diagram illustrating an example of a method of accelerating ray tracing.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

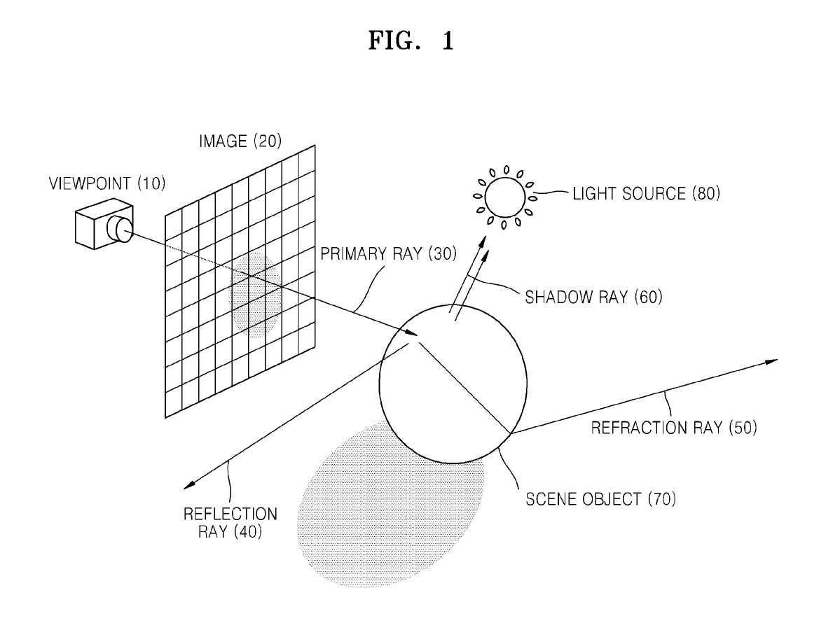

FIG. 1 is a diagram illustrating an example of ray tracing. Referring to FIG. 1, in three-dimensional (3D) modeling, a ray tracing core may determine a viewpoint 10 and an image 20 based upon the viewpoint 10. When the viewpoint 10 and the image 20 are determined, the ray tracing core generates a ray from the viewpoint 10 with respect to each pixel of the image 20.

In ray tracing, a primary ray 30 is generated from the viewpoint 10. The primary ray 30 intersects with a scene object 70 after passing the image 20. At an intersection point between the primary ray 30 and the scene object 70, a reflection ray 40 and a refraction ray 50 are generated. Also, a shadow ray 60 is generated at the intersection point toward a light source 80. The reflection ray 40, the refraction ray 50, and the shadow ray 60 are referred to as secondary rays. The scene object 70 denotes an object that is to be rendered with respect to the image 20. The scene object 70 includes a plurality of primitives.

The ray tracing core analyzes the primary ray 30, the secondary rays, i.e., the reflection ray 40, the refraction ray 50, and the shadow ray 60, and rays derived from the secondary rays. The ray tracing core determines a color value of each of pixels that form the image 20 based on a result of the analysis. The ray tracing core determines color values of pixels by considering characteristics of the scene object 70.

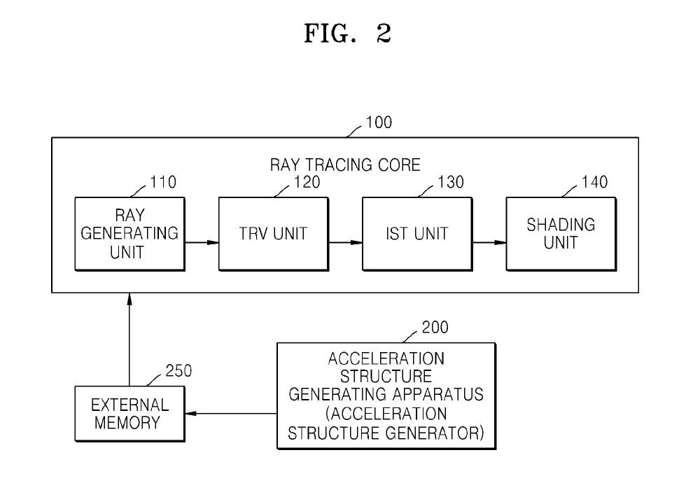

FIG. 2 is a diagram illustrating an example of a ray tracing core 100. Referring to FIG. 2, the ray tracing core 100 includes a ray generating unit 110, a traversal (TRV) unit 120, an intersection test (IST) unit 130, and a shading unit 140. In FIG. 2, the TRV unit 120 and the IST unit 130 are included in the ray tracing core 100, but the TRV unit 120 and the IST unit 130 may also be provided separately without departing from the spirit and scope of the illustrative examples described. The ray tracing core 100 of FIG. 2 includes only elements related to the illustrated example. However, it is understood that those skilled in the art may include other general elements in the ray tracing core 100.

The ray tracing core 100 traces an intersection point between generated rays and objects located in 3D space, and determines color values of pixels that form an image. The ray tracing core 100 searches for an intersection point between rays and objects, generate secondary rays based on characteristics of an object at the intersection point, and determines a color value of the intersection point. The ray tracing core 100 may use results of previous traversal and previous intersection tests in traversal of an acceleration structure and an intersection test. The ray tracing core 100 may perform current rendering faster by applying results obtained from previous renderings.

The ray generating unit 110 generates a primary ray and a secondary ray. The ray tracing core 100 generates a primary ray 30 from a viewpoint 10. The ray generating unit 110 generates a secondary ray at an intersection point between the primary ray 30 and an object 70. The ray generating unit 110 may generate a second secondary ray at an intersection point between the secondary ray and the object 70. The ray generating unit 110 may generate a reflection ray 40, a refraction ray 50, or a shadow ray 60 at an intersection point between the secondary ray and the object 70. The ray generating unit 110 may generate a reflection ray 40, a refraction ray 50, or a shadow ray 60 within a preset number of times. In another non-exhaustive example, the ray generating unit 110 may determine the number of times required to generate a reflection ray 40, a refraction ray 50, or a shadow ray 60 based on characteristics of an object 70.

The TRV unit 120 receives information about a ray generated by the ray generating unit 110. The generated ray may be a primary ray 30, a secondary ray, or a ray derived from the secondary ray. For example, regarding a primary ray 30, the TRV unit 120 may receive information about a viewpoint and a direction of a generated ray. Regarding a secondary ray, the TRV unit 120 may receive information about a starting point and a direction of a secondary ray. A starting point of a secondary ray denotes a point in a primitive that a primary ray has hit. A viewpoint or a starting point may be expressed in coordinates, and a direction may be expressed in vector notation.

The TRV unit 120 reads information about an acceleration structure from an external memory 250. An acceleration structure is generated by an acceleration structure generating apparatus 200, and the generated acceleration structure is stored in the external memory 250. An acceleration structure refers to a structure including position information of objects in 3D space. For example, an acceleration structure may be a K-dimensional (KD) tree or a bounding volume hierarchy (BVH).

The TRV unit 120 traverses an acceleration structure to output an object or a leaf node that a ray has hit. The TRV unit 120 searches for nodes included in an acceleration structure to output a leaf node which a ray has hit from among lowermost-ranking leaf nodes, to the IST unit 130. The TRV unit 120 determines which of bounding boxes that form an acceleration structure is hit by a ray. The TRV unit 120 determines which of objects included in a bounding box is hit by a ray. The TRV unit 120 stores information about an object that has been hit in a TRV cache. A bounding box denotes a unit including a plurality of objects or a plurality of primitives. A bounding box may be expressed in different forms according to an acceleration structure.

The TRV unit 120 may traverse an acceleration structure based on results of previous rendering. The TRV unit 120 may traverse an acceleration structure through the same route as a previous rendering based on the result of previous rendering that is stored in a TRV cache. When the TRV unit 120 traverses an acceleration structure regarding an input ray, the TRV unit 120 may initially traverse a bounding box that is hit by a previous ray having the same viewpoint and the same direction as the input ray. Also, the TRV unit 120 may traverse an acceleration structure by referring to a search route with respect to a previous ray. A TRV cache denotes a memory to temporarily store data used by the TRV unit 120 during traversal.

The IST unit 130 receives an object or a leaf node that is hit by a ray, from the TRV unit 120. The IST unit 130 reads information about primitives included in a hit object, from the external memory 250. Information about the read primitives may be stored in an IST cache. An IST cache denotes a memory to temporarily store data used by the IST unit 130 in an intersection test.

The IST unit 130 conducts an intersection test between a ray and a primitive to output a primitive hit by a ray and an intersection point. The IST unit 130 receives information about an object that is hit by a ray from the TRV unit 120. The IST unit 130 tests which of primitives are hit by a ray from among a plurality of primitives included in a hit object. The IST unit 130 searches for a primitive hit by a ray, and outputs an intersection point indicating which point of the hit primitive intersects the ray. The intersection point may be output to the shading unit 140 as coordinates.

The IST unit 130 may conduct an intersection test by using results of previous rendering. The IST unit 130 may initially conduct an intersection test on the same primitive as that of previous rendering based on results of previous rendering that are stored in the IST cache. When the IST unit 130 conducts an intersection test on an input ray, the IST unit 130 may initially conduct an intersection test on a primitive hit by a previous ray having the same viewpoint and the same direction as the input ray.

The shading unit 140 determines a color value of a pixel based on information about an intersection point, received from the IST unit 130, and properties of a material of the intersection point. The shading unit 140 determines a color value of a pixel by considering a basic color of a material of the intersection point and effects due to a light source.

The shading unit 140 may generate a secondary ray based on material information with respect to an intersection point. As different phenomena such as reflection or refraction occur based on properties of a material, the shading unit 140 may generate a secondary ray such as a reflection ray or a refraction ray according to the properties of a material. Also, the shading unit 140 may generate a shadow ray based on a position of a light source.

The ray tracing core 100 receives data needed in ray tracing, from the external memory 250. An acceleration structure or geometry data is stored in the external memory 250. An acceleration structure is generated by the acceleration structure generating apparatus 200 and is stored in the external memory 250. Geometry data denotes information about primitives. A primitive may be a polygon such as a triangle or a rectangle, and geometry may indicate information about a vertex and a position of primitives included in an object.

The acceleration structure generating apparatus 200 generates an acceleration structure including position information about objects in 3D space. In other words, the acceleration structure generating apparatus 200 splits 3D space in a hierarchical tree structure. The acceleration structure generating apparatus 200 may generate various types of acceleration structures. For example, the acceleration structure generating apparatus 200 may generate an acceleration structure indicating a relationship between objects in 3D space by applying BVH or KD tree. The acceleration structure generating apparatus 200 may determine a maximum number of primitives of a leaf node and a depth of tree and generate an acceleration structure based on the determined maximum number and the determined depth of tree.

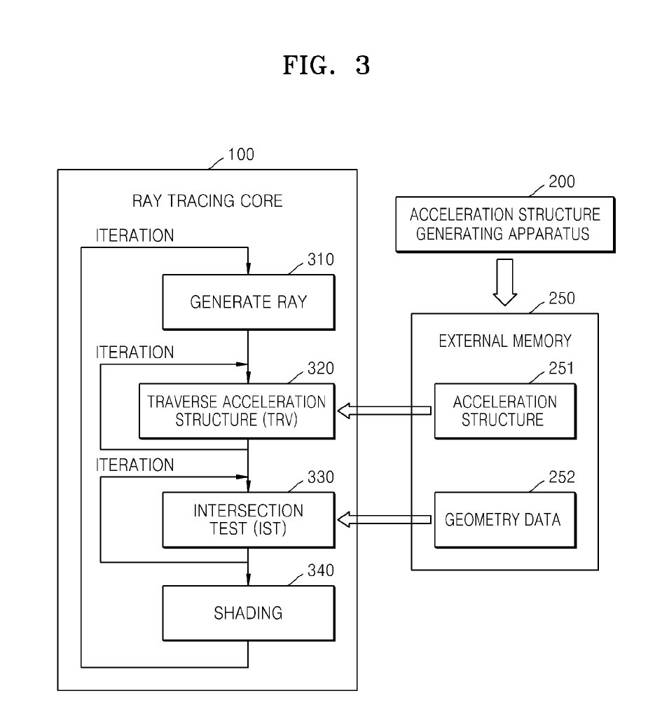

FIG. 3 is a diagram illustrating an example of ray tracing performed by the ray tracing core 100. The operations in FIG. 3 may be performed in the sequence and manner as shown, although the order of some operations may be changed or some of the operations omitted without departing from the spirit and scope of the illustrative examples described. Many of the operations shown in FIG. 3 may be performed in parallel or concurrently. FIG. 3 may also be described as a schematic view to explain an operation of the example ray tracing core 100 illustrated in FIG. 2. Accordingly, descriptions of the ray tracing core 100 also apply to ray tracing of FIG. 3, and will not be repeated here.

In operation 310, the ray tracing core 100 generates a ray. The ray tracing core 100 generates a primary ray, a secondary ray, and rays derived from the secondary ray.

In operation 320, the ray tracing core 100 traverses an acceleration structure 251. The acceleration structure 251 is read from the external memory 250. The ray tracing core 100 detects a bounding box hit by a ray, by traversing the acceleration structure 251 based on a viewpoint and a direction of generated rays. Also, the ray tracing core 100 detects an object hit by a ray from among objects included in the hit bounding box. The ray tracing core 100 repeats traversing the acceleration structure 251 until a hit object is detected. The ray tracing core 100 traverses an acceleration structure along a predetermined route, and when a leaf node on the searched route is not hit by a ray, the ray tracing core 100 traverses other routes in an acceleration structure.

The ray tracing core 100 may sequentially traverse all routes but may initially traverse a predetermined route based on search information of a previous ray. The ray tracing core 100 may initially search for a route in which a hit leaf node is included in a previous node when the previous ray has the same or similar viewpoint and the same or similar direction as a current ray.

In operation 330, the ray tracing core 100 conducts an intersection test. The ray tracing core 100 reads geometry data 252 of primitives from the external memory 250. The ray tracing core 100 conducts an intersection test based on the geometry data 252 that it read. The ray tracing core 100 iterates an intersection test until a hit primitive is detected. The ray tracing core 100 conducts an intersection test on a primitive, and when any primitive is hit by a ray, the ray tracing core 100 conducts an intersection test on another primitive.

The ray tracing core 100 may sequentially conduct an intersection test on all primitives but may also initially test a predetermined primitive based on information about an intersection test of a previous ray. The ray tracing core 100 may initially conduct an intersection test on a primitive that is hit by a previous ray when the previous ray and a current ray have the same or similar viewpoint and the same or similar direction.

In operation 340, the ray tracing core 100 conducts shading of a pixel based on the intersection test. After operation 340 is completed, the ray tracing core 100 proceeds to operation 310. The ray tracing core 100 iterates operations 310 through 340 with respect to all pixels that form an image.

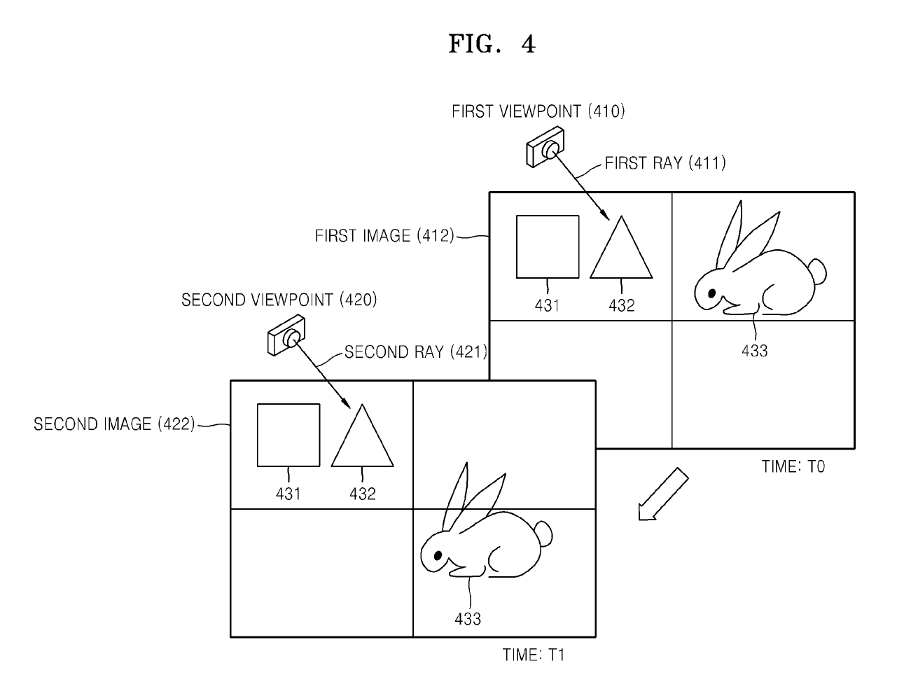

FIG. 4 is a diagram illustrating an example of a method of accelerating ray tracing. Referring to FIG. 4, a first image 412 is an image that is rendered at t=0, and a second image 422 is an image that is rendered at t=1. As only one object 433 has moved between the first image 412 and the second image 422, the first image 412 and the second image 422 are similar. Accordingly, the ray tracing core 100 may conduct rendering with respect to the second image 421 by using a result of rendering the first image 412. For example, when a first viewpoint 410 and a second viewpoint 420 are at the same position, and a first ray 411 and a second ray 421 are in the same direction, the ray tracing core 100 may accelerate ray tracing of the second ray 421 by applying a result of ray tracing with respect to the first ray 411. The TRV unit 120 of the ray tracing core 100 may initially traverse a bounding box hit by the first ray 411 when conducting a search with respect to the second ray 421. The IST unit 130 of the ray tracing core 100 may initially conduct an intersection test on a triangle 432 hit by the first ray 411 during an intersection test on the second ray.

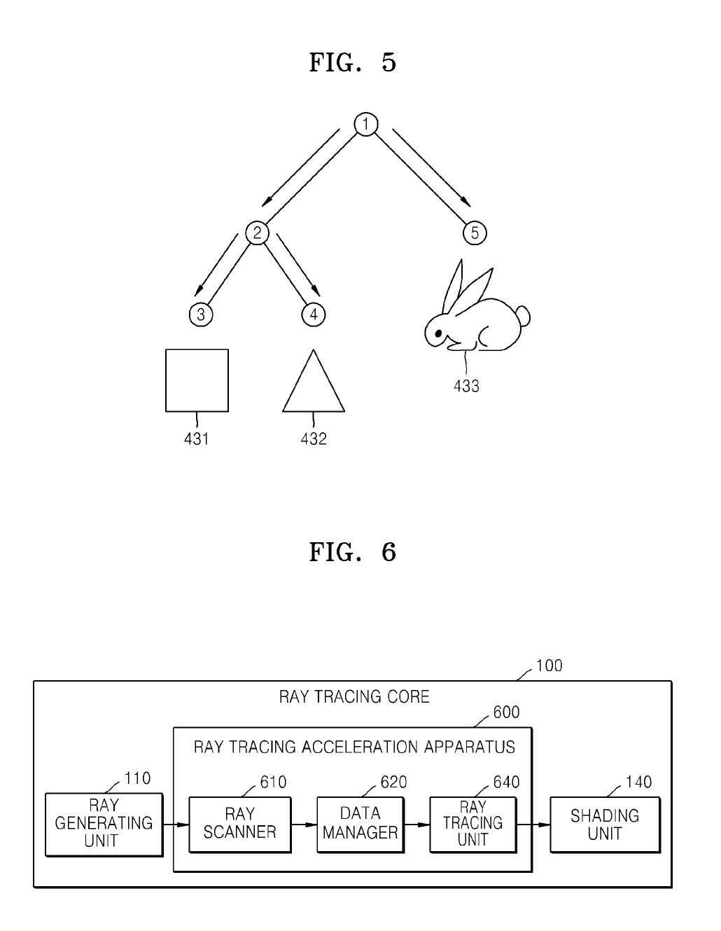

FIG. 5 is a diagram illustrating an example of a method of accelerating ray tracing of FIG. 4. Referring to FIG. 5, an acceleration structure includes five nodes, node 1 through 5, and nodes 3 through 5 each denote a leaf node.

The TRV unit 120 may search an acceleration structure along three routes. First, the TRV unit 120 may traverse an acceleration structure along a first route, i.e., along node 1, node 2, and node 3. Secondly, the TRV unit 120 may traverse an acceleration structure along a second route, i.e., node 1, node 2, and node 4. Thirdly, the TRV unit 120 may traverse an acceleration structure along a third route, i.e., node 1 and node 5. When the TRV unit 120 conducts a search with respect to the second ray 421, the TRV unit 120 initially traverses the second route through which a triangle 432 hit by the first ray 411 is searched. Accordingly, the TRV unit 120 may omit an operation of traversing the first route or the third route.

FIG. 6 is a diagram illustrating an example of a ray tracing apparatus. Referring to FIG. 6, the ray tracing apparatus 600 includes a ray scanner 610, a data manager 620, and a ray tracing unit 640. The ray tracing apparatus 600 may be included in the ray tracing core 100.

The ray scanner 610 extracts characteristics of a ray generated for rendering a current frame. The ray is generated using the ray generating unit 110 to render a current frame. For example, characteristics of a ray may indicate a viewpoint and a direction of the ray. The characteristics of a ray may also include information indicating a pixel of an image to which the ray is related. For a secondary ray, ray characteristics may include a starting point and a direction of a ray. The ray scanner 610 outputs the extracted ray characteristics to the data manager 620.

The data manager 620 compares characteristics of the generated ray with characteristics of rays used in previous rendering to determine whether any ray from among the previously used rays has characteristics that are most similar to those of the generated ray. The data manager 620 compares a viewpoint of the generated ray with viewpoints of the used rays. The data manager 620 compares a direction of the generated ray with directions of the used rays. The data manager 620 determines any one ray among the rays used in previous rendering based on a result of the comparison. The determined ray is a ray that is most similar to the generated ray.

The data manager 620 may determine rays that are within a predetermined range of the viewpoint and the direction of the generated ray, as rays belonging to the same group, from among the used rays. The data manager 620 may determine those used rays having a viewpoint within a predetermined distance with respect to the viewpoint of the generated ray, and determine those used rays having a vector indicating the direction of the generated ray and a vector having a predetermined angle, as the same group. The data manager 620 outputs a result of ray tracing of the used rays in the same group, to the ray tracing unit 640.

The ray tracing unit 640 conducts ray tracing of the generated ray based on a result of ray tracing of the determined ray. The result of the ray tracing of the determined ray indicates a result of traversal of an acceleration structure and a result of an intersection test conducted in previous rendering.

A result of traversal of an acceleration structure indicates a bounding box among those included in an acceleration structure that is hit by the determined ray. A result of traversal of an acceleration structure indicates an object among those included in a bounding box that is hit by the determined ray. A result of an intersection test indicates a primitive among those included in the hit object that is hit by the determined ray.

The ray tracing unit 640 initially conducts a traversal with respect to a bounding box or an object that is hit by the determined ray. Also, the ray tracing unit 640 initially conducts an intersection test on a primitive hit by the determined ray. As a bounding box that is farther from a viewpoint than the bounding box hit by the determined ray is not hit by the determined ray, the ray tracing unit 640 may not perform a traversal with respect to a bounding box that is farther from a viewpoint than the bounding box hit by the determined ray.

As a result of traversal with respect to the bounding box hit by the determined ray, if the generated ray has not hit the bounding box that is hit by the determined ray, the ray tracing unit 640 performs a traversal with respect to another bounding box.

The ray tracing unit 640 may perform ray tracing of the generated ray based on a result of ray tracing of the rays determined to be in the same group. The ray tracing unit 640 may initially perform traversal with respect to bounding boxes that are hit by the rays determined to be in the same group.

The data manager 620 stores information about a bounding box hit by the generated ray. The data manager 620 may update the information about the determined ray to information about the generated ray. That is, the data manager 620 updates information about the determined ray stored in a memory or a cache, to information about a bounding box hit by the generated ray. The ray tracing unit 640 outputs an intersection point to the shading unit 140 as a result of the intersection test. The shading unit 140 designates a color of the received intersection point.

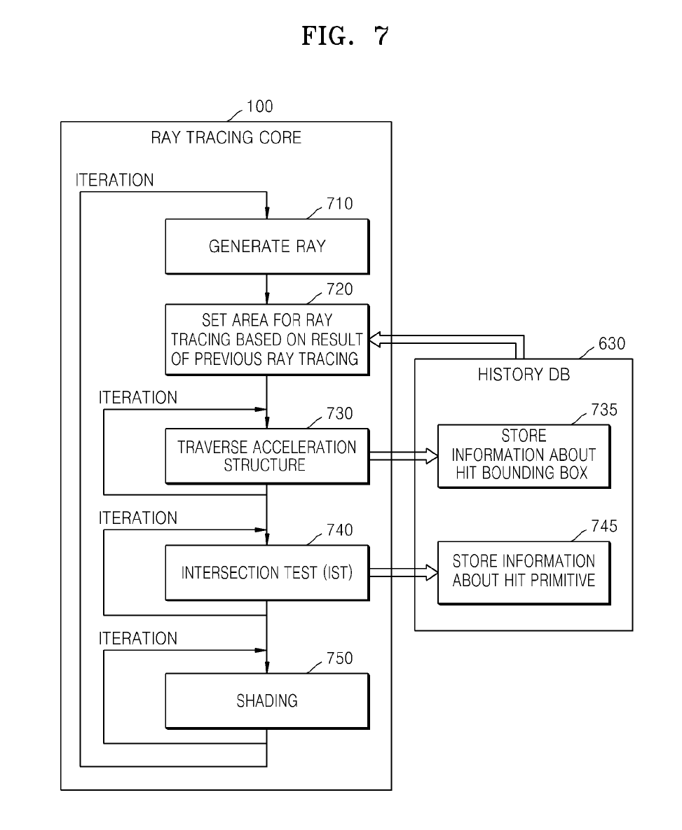

FIG. 7 is a diagram illustrating an example of a ray tracing method. The operations in FIG. 7 may be performed in the sequence and manner as shown, although the order of some operations may be changed or some of the operations omitted without departing from the spirit and scope of the illustrative examples described. Many of the operations shown in FIG. 7 may be performed in parallel or concurrently. The above descriptions of the ray tracing core 100 of FIG. 6, is also applicable to FIG. 7, and is incorporated herein by reference. Thus, the above description may not be repeated here. Referring to FIG. 7, the ray tracing core 100 may set an area for ray tracing based on a result of previous ray tracing.

In operation 710, the ray generating unit 110 of the ray tracing core 100 generates a ray.

In operation 720, the data manager 620 of the ray tracing core 100 sets an area for ray tracing based on a result of previous ray tracing. The data manager 620 performs ray tracing with respect to a ray generated using the ray generating unit 110. The data manager 620 sets an area in which ray tracing with respect to the generated ray is to be initially performed. For example, the data manager 620 performs ray tracing with respect to a preset bounding box included in an acceleration structure. The data manager 620 receives information about a bounding box hit by a ray used in a previous frame, from a history DB 630. The data manager 620 sets an area for traversal of an acceleration structure with respect to the generated ray based on the information received from the history DB 630.

The data manager 620 performs ray tracing with respect to a preset primitive included in a bounding box. The data manager 620 receives information about a primitive hit by a ray used in a previous frame, from the history DB 630. The data manager 620 sets an area for an intersection test of the generated ray with respect to the generated ray based on the information received from the history DB 630.

In operation 730, the TRV unit 120 of the ray tracing core 100 traverses an acceleration structure of the generated ray. The TRV unit 120 initially searches the area set in operation 720 when searching an acceleration structure. The TRV unit 120 initially searches a bounding box hit by a previous ray that is most similar to the generated ray. The TRV unit 120 searches another bounding box when the generated ray has not hit the initially searched bounding box. The TRV unit 120 searches an acceleration structure until a hit bounding box is found.

In operation 735, the TRV unit 120 stores information about a bounding box hit by the generated ray, in the history DB 630.

In operation 740, the IST unit 130 of the ray tracing core 100 performs an intersection test on the generated ray. When performing an intersection test, the IST unit 130 initially searches the area set in operation 720. The IST unit 130 initially searches a primitive hit by a previous ray that is most similar to the generated ray. When the generated ray is not hit by the initially searched primitive, the IST unit 130 performs an intersection test on another primitive. When the generated ray has not hit the initially searched primitive, the IST unit 130 may perform an intersection test on primitives included in the bounding box set in operation 720. The IST unit 130 repeats the intersection test until a hit primitive is found.

In operation 745, the IST unit 130 stores information about a primitive hit by the generated ray, in the history DB 630. In operation 750, the shading unit 140 of the ray tracing core 100 determines a color of an intersection point which the generated ray has hit. After completing operation 750, the method proceeds to operation 710 for shading of a new ray.

The ray tracing core 100 performs rendering of a next frame by using a rendering result of a previous frame. A result of rendering that is performed when T=0 is used when rendering is performed at T=1, and a result of rendering that is performed when T=1 is used when rendering is performed at T=2. Rendering may be performed quickly because rendering performed at similar time points is similar. The ray tracing core 100 may update stored rendering results when rendering of each frame is completed, and may use the result in rendering of a next frame.

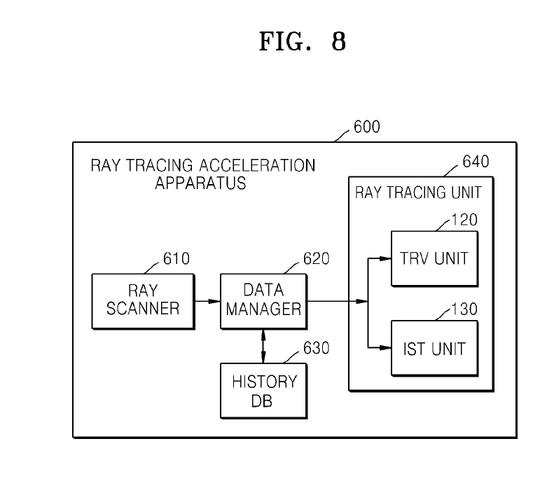

FIG. 8 is a diagram illustrating an example of a ray tracing apparatus 600. The ray tracing apparatus 600 of FIG. 8 is another example of the ray tracing apparatus 600 of FIG. 6, description of the ray tracing apparatus 600 of FIG. 6, provided above, also applies to the ray tracing apparatus 600 of FIG. 8, and is incorporated herein by reference. Thus, the above description may not be repeated here.

Referring to FIG. 8, the ray tracing apparatus 600 further includes the history DB 630, and the ray tracing unit 640 includes the TRV unit 120 and the IST unit 130.

The history DB 630 stores characteristics of rays used in previous rendering and the results of ray tracing of the previous rendering. The history DB 630 stores information about rays used in previous rendering and outputs the stored information to the data manager 620. Results of ray tracing include a result of a traversal of an acceleration structure or a result of an intersection test that is performed in previous rendering. For example, results of ray tracing may include information about which ray is hit by which bounding box or which primitive.

The data manager 620 compares a current ray with previous rays. The data manager 620 receives characteristics of the current ray extracted by using the ray scanner 610. Also, the data manager 620 receives characteristics of previous rays from the history DB 630. The data manager 620 compares characteristics of a current ray with those of previous rays.

The data manager 620 outputs a result of ray tracing of previous rays to the ray tracing unit 640. The data manager 620 outputs a result of traversal of an acceleration structure of previous rays. Also, the data manager 620 outputs a result of an intersection test on previous rays, to the IST unit 130.

The ray tracing unit 640 performs ray tracing with respect to a current ray by using information received from the data manager 620. The TRV unit 120 performs traversal with respect to a current ray based on a result of traversal of an acceleration structure with respect to a previous ray received from the data manager 620. Also, the IST unit 130 performs an intersection test on a current ray based on a result of an intersection test on a previous ray received from the data manager 620.

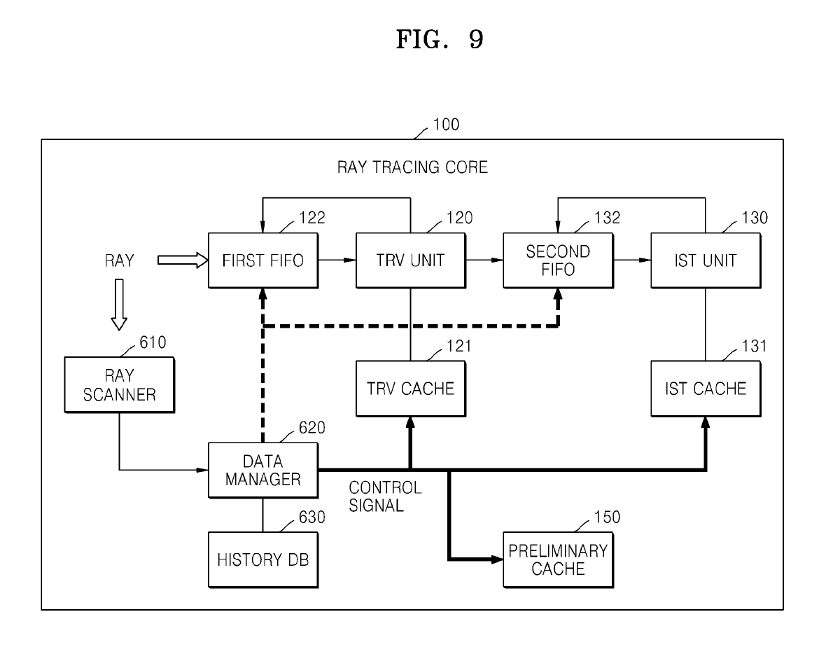

FIG. 9 is a diagram illustrating an example of a ray tracing core 100. Referring to FIG. 9, the ray tracing core 100 extracts characteristics of rays, and performs ray tracing based on the characteristics of rays. The ray tracing core 100 controls the TRV unit 120 or the IST unit 130 based on a result of ray tracing of a previous ray.

The data manager 620 may control an order of ray tracing of the TRV unit 120 or the IST unit 130.

The data manager 620 may designate a node or path to be initially searched, when the TRV unit 120 searches an acceleration structure. The TRV unit 120 initially searches the node or path designated by the data manager 620.

The data manager 620 may designate a primitive to be initially tested when the IST unit 130 performs an intersection test. The IST unit 130 performs an intersection test on the primitive designated by the data manager 620.

The TRV unit 120 reads a ray stored in a first FIFO 122, and performs a search of an acceleration structure with respect to the read ray.

The IST unit 130 reads a ray stored in a second FIFO 132 and performs an intersection test on the read ray.

The first FIFO 122 and the second FIFO 132 are predetermined buffers that sequentially store generated rays. For example, the first FIFO 122 sequentially outputs generated rays to the TRV unit 120. The second FIFO 132 sequentially outputs generated rays to the IST unit 130.

The TRV unit cache 121 stores information about a bounding box hit by a previous ray. When a current ray has hit the same bounding box as a previous ray, the TRV unit 120 uses the same information about the bounding box stored in the TRV cache 121, and thus, cache misses of the TRV unit 120 may be reduced.

The IST cache 131 stores information about a primitive hit by a previous ray. When a current ray is hit by the same primitive as a previous ray, the IST unit 130 uses the same information of the primitive stored in the IST cache 131, and thus, cache misses of the IST unit 130 may be reduced.

The preliminary cache 150 temporarily stores information stored in the TRV cache 121 or the IST cache 131. The data manager 620 may load the information stored in the TRV cache 121 or the IST cache 131 when it is determined that the information stored in the TRV cache 121 or the IST cache 131 is to be reused.

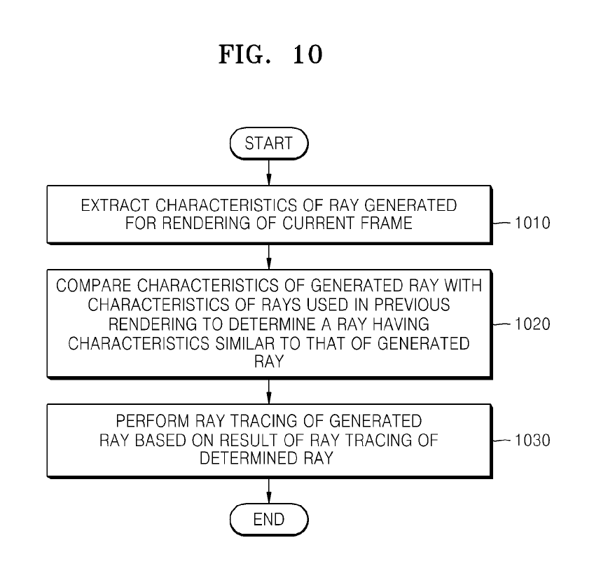

FIG. 10 is a diagram illustrating an example of a method of accelerating ray tracing. The operations in FIG. 10 may be performed in the sequence and manner as shown, although the order of some operations may be changed or some of the operations omitted without departing from the spirit and scope of the illustrative examples described. Many of the operations shown in FIG. 10 may be performed in parallel or concurrently.

In operation 1010, the ray tracing apparatus 600 extracts characteristics of a ray generated for rendering of a current frame.

In operation 1020, the ray tracing apparatus 600 compares characteristics of the generated ray with those of rays used in rendering of a previous frame to determine any one ray having characteristics that are most similar to the characteristics of the generated ray, from among the used rays.

In operation 1030, the ray tracing apparatus 600 performs ray tracing of the generated ray based on a result of ray tracing of the determined ray.

As described above, rendering of a current frame may be performed by using a result of ray tracing performed during rendering of a previous frame, and thus, rendering of the current frame may be performed quickly. When performing ray tracing of a generated ray, a bounding box which is hit by a previous ray is initially searched, thereby quickly performing traversal of an acceleration structure. When performing ray tracing of a generated ray, a bounding box hit by previous rays that are determined as the same group is searched initially, thereby quickly performing traversal of an acceleration structure. When performing ray tracing of a generated ray, an intersection test on a primitive that is hit by a previous ray is performed initially, thereby quickly performing the intersection test.

The processes, functions, and methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

The apparatuses and units described herein may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a hardware component may include multiple processors or a processor and a controller. In addition, different processing configurations are possible, such a parallel processors.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A ray tracing method comprising:
extracting, at a ray scanner, characteristics of a ray generated to render a current frame;
determining a ray having characteristics similar to that of the generated ray based on comparing the characteristics of the generated ray with characteristics of rays used to render a previous frame; and
performing ray tracing of the generated ray based on a result of ray tracing of the determined ray.

2. The ray tracing method of claim 1, wherein the performing of the ray tracing comprises initially traversing a bounding box of an acceleration structure that is hit by the determined ray.

3. The ray tracing method of claim 2, wherein the performing of the ray tracing comprises traversing a second bounding box of the acceleration structure, in response to the bounding box not being hit.

4. The ray tracing method of claim 2, wherein bounding boxes farther from a viewpoint of the ray than the bounding box are not traversed.

5. The ray tracing method of claim 1, wherein the performing of the ray tracing comprises initially performing an intersection test on a primitive in the acceleration structure that is hit by the determined ray.

6. The ray tracing method of claim 1, wherein the determining of the ray comprises determining the rays whose viewpoint and direction are within a predetermined range from a viewpoint and a direction of the generated ray as belonging to a group, and the performing of the ray tracing comprises performing the ray tracing of the generated ray based on a result of ray tracing of rays of the group.

7. The ray tracing method of claim 1, wherein the extracting comprises extracting a viewpoint and a direction of the generated ray in response to the generated ray being a primary ray, and extracting a starting point and a direction of the generated ray in response to the generated ray being a secondary ray.

8. The ray tracing method of claim 1, wherein the determining of the ray comprises comparing a viewpoint and a direction of the generated ray and viewpoints and directions of the rays used to render the previous frame to determine the ray having a viewpoint and a direction similar to the viewpoint and the direction of the generated ray.

9. The ray tracing method of claim 1, further comprising storing a result of ray tracing of the generated ray,
wherein the result of the ray tracing comprises information indicating a bounding box or a primitive that is hit by the generated ray.

10. A non-transitory computer readable recording medium having embodied thereon a program for executing the method of claim 1.

11. A ray tracing apparatus comprising:
a ray scanner configured to extract characteristics of a ray generated for rendering a current frame;
a data manager configured to determine a ray having characteristics similar to that of the generated ray based on comparing the characteristics of the generated ray with characteristics of rays used in rendering a previous frame; and
a ray tracer configured to perform ray tracing of the generated ray based on a result of ray tracing of the determined ray.

12. The ray tracing apparatus of claim 11, wherein the ray tracer is further configured to initially traverse a bounding box of an acceleration structure that is hit by the determined ray.

13. The ray tracing apparatus of claim 12, wherein the ray tracer is further configured to exclude traversal of the bounding box that is farther from a viewpoint of the ray than the bounding box hit by the determined ray.

14. The ray tracing apparatus of claim 11, wherein the ray tracer is further configured to initially performs an intersection test on a primitive in an acceleration structure that is hit by the determined ray.

15. The ray tracing apparatus of claim 11, wherein the data manager is further configured to determine rays whose viewpoint and direction are within a predetermined range from a viewpoint and a direction of the generated ray as belonging to a group, and
the ray tracer is further configured to perform ray tracing of the generated ray based on a result of ray tracing of rays of the group.

16. The ray tracing apparatus of claim 11, wherein the ray scanner is further configured to extract a viewpoint and a direction of the generated ray in response to the generated ray being a primary ray, and to extract a starting point and a direction of the generated ray in response to the generated ray being a secondary ray.

17. The ray tracing apparatus of claim 11, wherein the data manager is further configured to compare viewpoints and directions of the generated ray and viewpoints and directions of the rays used to render the previous frame to determine the ray having a viewpoint and a direction similar to the viewpoint and the direction of the generated ray.

18. The ray tracing apparatus of claim 11, wherein the data manager is further configured to store a result of ray tracing comprising information indicating a bounding box or a primitive that is hit by the generated ray.

19. A ray tracing apparatus comprising:
a ray scanner configured to extract characteristics of a ray generated for rendering a current frame; and
a data manager configured to determine a ray having characteristics similar to that of the generated ray based on comparing the characteristics of the generated ray with characteristics of rays used in rendering a previous frame,
wherein the data manager is further configured to control at least one of a TRV unit or a IST unit to perform ray tracing of the generated ray based on a result of ray tracing of the determined ray.

20. The ray tracing apparatus of claim 19, wherein the TRV unit is configured to initially traverse a bounding box of an acceleration structure that is hit by the determined ray.

21. The ray tracing apparatus of claim 19, wherein the IST unit is configured to initially performs an intersection test on a primitive in an acceleration structure that is hit by the determined ray.
